(19) United States
(12) Patent Application Publication
(10) Pub. No.: US 2010/0175190 A1
(43) Pub. Date: Jul. 15, 2010

(54) Comfortable bed preventing bed sores for invalids and sleep disturbing patient

(76) Inventor: Jin Rie, Los Angeles, CA (US)

Correspondence Address: Jin Rie, 401 N. Bixel St., Los Angeles, CA, 90026, US

(21) Appl. No.: 12/319,694

(22) Filed: Jan. 12, 2009

(51) Int. Cl. A61G 7/043; A47C 21/08; A61G 7/05

(52) U.S. Cl. 5/600; 5/424

(57) ABSTRACT

A comfortable bed is provided. The bed comprises of one head panel, one foot panel, two side support panels, one bed plate, one removable key-hole shape panel, and two side bottom frames. Each of the two side support panels comprises of a rigid portion and a soft resilient portion. The resilient portion comprises of one body of soft rubbery material, such as poly-urethane or silicon rubber, one side of which has two smooth rounded humps and the other side is straight. The soft resilient portion allows the user to lean his/her hand or leg with comfort and help the user fall a sleep easily. A key hole shape panel and groove developed on the bed plate helps the user when excretion is needed with help of an assistant.

### FIELD OF THE INVENTION

Current application relates to a bed, especially to a bed that has side support plates to enable a user fall asleep easily and exercise or stretch more comfortably and more efficiently.

### BACKGROUND OF THE INVENTION

In spite of so many different types of bed on the market, including hospital bed, no bed is equipped with a function of providing comfortable, safe and helping user fall asleep easily. The applicant had a grandfather who suffered long time for his old age related sickness. So the applicant's grandfather has to stay on the bed for couple of years. But hospitals do not want to keep him therein due to his old age. And the applicant's grandfather wants to end his life with his family. So, the applicant's uncle should bring him to his house and took care of him for couple of years. Since the applicant's grandfather is in bed, he was suffered from the decubitus due to long time stay on the bed. And it was very hard for the grandfather to get sleep. The applicant's uncle searched many different types of beds that can be used for a weak senior like his father. But, most of the beds for patients are too much expensive and too much complex to be operated by an average people. In addition to that, those beds are not designed for patients who should stay there for an extended time. It is purpose of the current application to provide a bed that is comfortable, safe and helps a user get asleep easily, while it is economically affordable at the same time.

### DESCRIPTION OF THE PRIOR ARTS

U.S. Pat. No. 7,076,817 to Garver illustrates a convalescent bed for safely restraining a bedridden patient includes a bed frame with a mattress that is raised and lowered by a hydraulic or electric lifting arm.

U.S. Pat. No. 7,047,991 to Kline illustrates a bed enclosure comprising a frame, a tent supported by the frame, and a mattress cover is disclosed.

U.S. Pat. Nos. 6,594,835, 5,592,705 and 5,052,065 to West illustrates an impact-cushioning device, which is designed to prevent injury when an occupant, confused or otherwise, falls from a height.

U.S. Patent Application 20050235418 by Jacques, William L. II; et al. illustrates a bed enclosure for a health care facility bed including a frame and a mattress to support a patient. U.S. Patent Application 20050217026 by Ramirez, Elizabeth illustrates a device with a support for a mattress to accommodate a person on the mattress which includes a frame work including connectors to secure the framework in upstanding relation peripherally about the mattress.

U.S. Pat. No. 6,931,684 to Henegar illustrates a bed provided with a mattress having a removable insert; the insert incorporates an opening therein to receive a seat.

U.S. Pat. Nos. 6,928,673 and 6,615,426 to Risk, Jr. discloses a side rail apparatus for a side rail of a hospital bed is provided that is coupled to the side rail.

U.S. Pat. No. 6,802,088 to Gruner discloses a portable bed device comprising a horizontal bottom surrounded by vertical walls with an open top forming a tub for holding water therein.

U.S. Pat. No. 6,622,323 to Zerhusen, et al. illustrates a bed side rail for a bed having a frame includes a flexible section to allow a portion of the side rail to flex upward.

U.S. Pat. No. 6,543,068 to Penninger discloses a portable bed-bath and shower device.

U.S. Pat. No. 6,453,491 to Wells, et al. illustrates a safety bed including a wooden bed frame which supports a mattress, a footboard attached to one lateral side of said support structure, a headboard disposed at an opposing end of said support structure, and a pair of lateral side rails interconnecting the footboard and the headboard on opposing sides of the bed frame.

U.S. Pat. No. 6,272,702 to Uchida, et al. illustrates a multifunction bed that has a simple structure to allow its size to be reduced and that can be automatically changed between a bed form and a wheelchair form.

U.S. Pat. No. 5,911,654 to Webb illustrates a cover and cushion ensemble for a hospital bed.

U.S. Pat. No. 5,604,943 to Kimura, et al. illustrates a bed system with an excreting mechanism.

U.S. Pat. No. 5,355,540 to Allen illustrates a bed for patients requiring bed treatment having a cut out in the base beneath which is a toilet pan.

U.S. Pat. No. 5,331,698 to Newkirk, et al. illustrates a mattress for a birthing bed has three bladders inserted within a foam slab.

U.S. Pat. No. 5,193,232 to Flood, et al. illustrates a collapsible bed-pan support or pad for bed-ridden persons.

U.S. Pat. No. 4,953,246 to Matthews illustrates a cubicle bed for protectively confining a traumatically brain injured patient or the like.

However, none of the prior art illustrates a comfortable bed that prevents bed sores for invalids and sleep disturbing patient.

### SUMMARY OF THE INVENTION

In spite of so many different types of bed on the market, including hospital bed, no bed is equipped with a function of providing comfortable, safe and helping user fall asleep easily. The applicant had a grandfather who suffered long time for his old age related sickness. So the grandfather has to stay on the bed for couple of years. But hospitals do not want to keep him therein due to his old age. And the grandfather wants to end his life with his family. So, the applicant's uncle should bring him to his house and took care of him for couple of years. Since the grandfather is in bed, he was suffered from the decubitus due to long time stay on the bed. And it was very hard for him to get sleep. The applicant's uncle searched many different types of beds that can be used for a weak senior like his father. But, most of the beds for patients are too much expensive and too much complex to be operated by an average people. In addition to that, those beds are not designed for patients who should stay there for an extended time. It is purpose of the current application to provide a bed that is comfortable, safe and helps a user get asleep easily and exercise or stretch more comfortably and more efficiently, whereas it is economically affordable at the same time. Hereby, a comfortable bed is provided. The bed is comprised of one head panel, two side support panels, one bed plate, one removable key-hole shape panel, and two side bottom frames. The two side support panels are comprised of a rigid portion and a soft resilient portion. The resilient portion is comprised of a wave shaped soft rubbery material such as polyurethane or silicone rubber. The soft resilient portion allows the user to lean his/her hand or leg with comfort and help the user fall asleep easily. A key hole shape panel and groove developed on the bed plate helps the user when excretion is needed with help of an assistant.

### BRIEF DESCRIPTION OF THE DRAWINGS

FIG. 1 is a perspective view of a comfortable bed according to current application.

FIG. 2 is a front view of the comfortable bed according to current application seen from the view point A in FIG. 1.

FIG. 3 is a schematic drawing that shows how the resilient portion make a user falls asleep easily.

FIG. 4 is another schematic drawing that shows how the resilient portion make a user rest on the bed according to the current application.

FIG. 5 is a perspective drawing that shows the key hole shape panel and the groove there of.

FIG. 6 is a schematic drawing that shows how the key hole shape panel is used.

FIG. 7 is a cross sectional view of the bed seen from the B-B′ cut away line showing the folding mechanism of the side support panels.

FIG. 8 is a schematic drawing of the bed according to current application when one of the side support is folded down.

### DETAILED DESCRIPTION OF THE PREFERRED EMBODIMENT

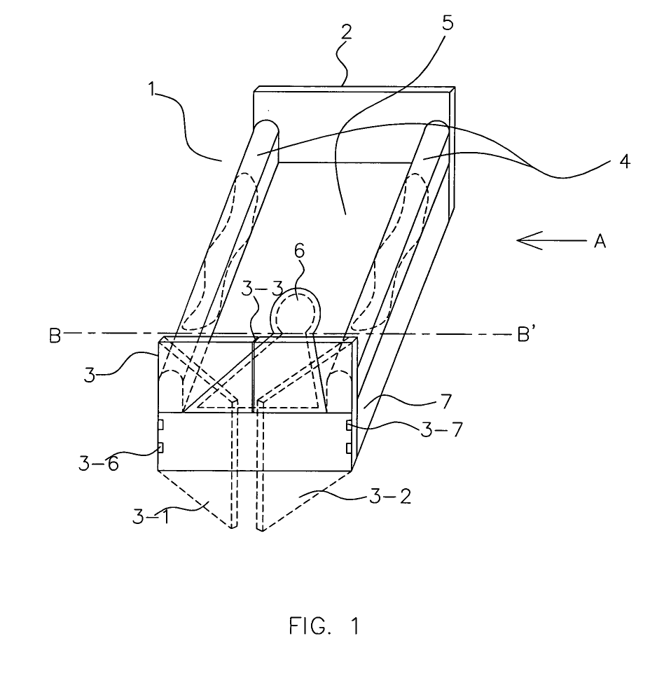

FIG. 1 is a perspective view of a comfortable bed (1) according to current application. The bed (1) is comprised of one head panel (2), two side support panels (4), one bed plate (5), one removable key-hole shape panel (6), and two side bottom frames (7). One foot panel (3) may be added to the structure.

The purpose of current application is to provide a comfortable bed that prevents bed sores for invalids and sleep disturbing patients at the same time and exercise or stretch more comfortably and more efficiently. The two side support panels (4) provide those functions.

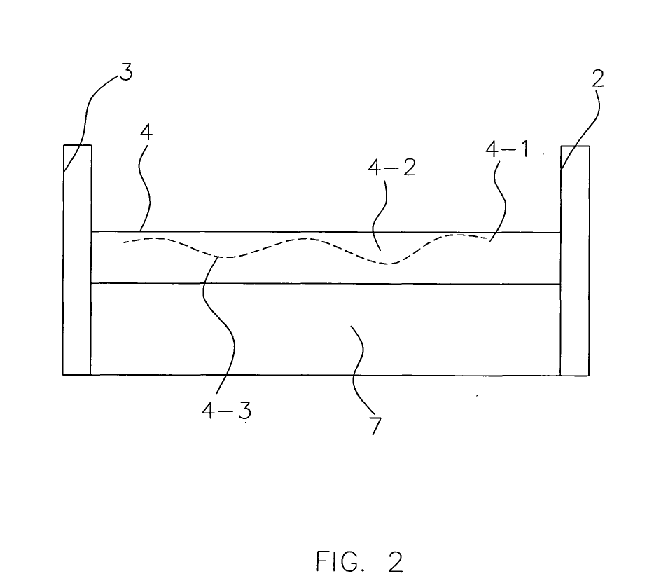

FIG. 2 is a front view of the comfortable bed (1) according to current application seen from the view point A in FIG. 1. The side support panels (4) of the bed (1) is comprised of a rigid portion (4-1) and a soft resilient portion (4-2). The resilient portion (4-2) is comprised of a wave shaped soft rubbery material such as polyurethane or silicone rubber. Surface of the side support panels are covered with soft textile, leather or artificial leathers.

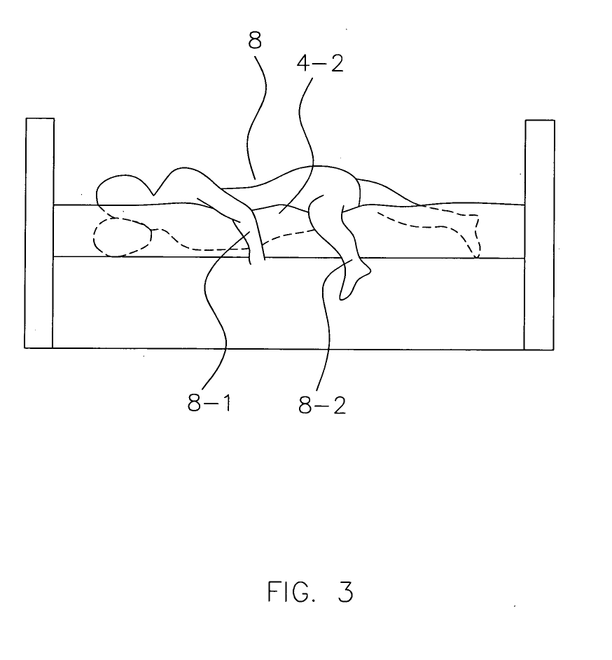

FIG. 3 is a schematic drawing that shows how the resilient portion make a user (8) fall asleep easily. Many people experienced that it is comfortable to put a arm or leg put on a some soft object when he/she tries to fall asleep and exercise or stretch more comfortably and more efficiently. Sometimes, people use a pillow or blanket for that purposes. But, none of the bed on the market comes with such kind of comfortable functions. The soft resilient portion (4-2) allows the user (8) to lean his/her arm (8-1) or leg (8-2). This position make the user feel like sleep on ‘Mother's body’ or ‘Spouse's body’ and make the user fall asleep fast. At the same time, it prevents bed sore by allowing the user sleep in a different position safely. If the user is a long term patient that should be in bed for an extended time, the bed of the current application will provide a bed sore preventing bed. Also prevents the decubitus by allowing the patient lie side way with support.

Even for a normal user (8), resting arm (8-1) or leg(8-2) on the soft resilient portion (4-2) distribute the body weight and releases stress of the body and helps the user sleep comfortably.

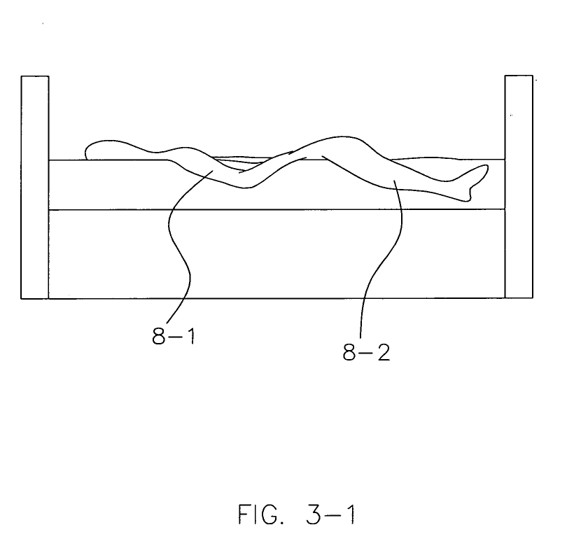

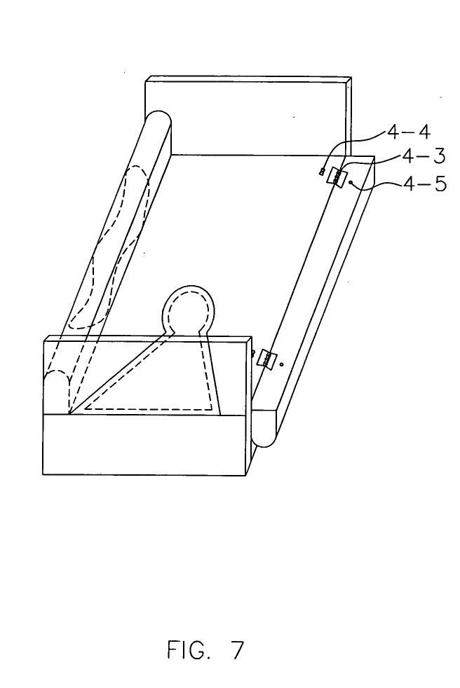

FIG. 4 is another schematic drawing that shows how the resilient portion make a user (8) rest on the bed according to the current application. The applicant found that put an arm (8-1) or leg (8-2) on the soft resilient portion (4-2) back wards gave him very comfortable position. When there is no foot panel (3) and the other side panel is down (See FIG. 8) or does not exists, it is very comfortable to watch a T.V. with that position. Taking that position is like doing a stretching or passive or active exercising.

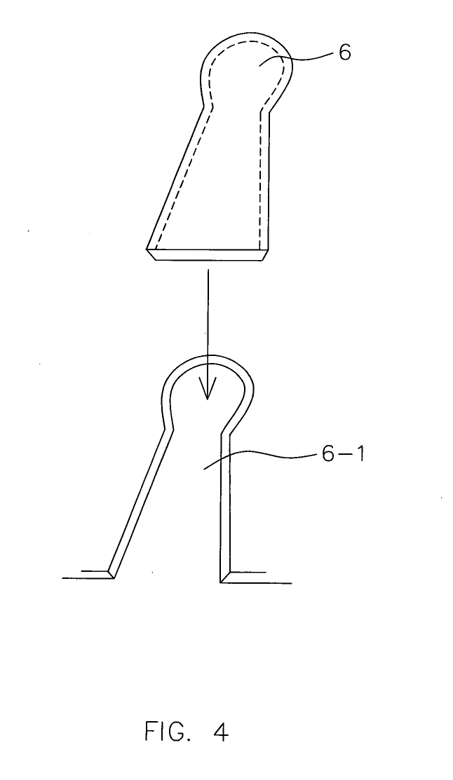

FIG. 5 is a perspective drawing that shows the key hole shape panel (6) and the groove (6-1) therefore. The key hole shape panel is comprised of the same material that constitutes the bed plate (5).

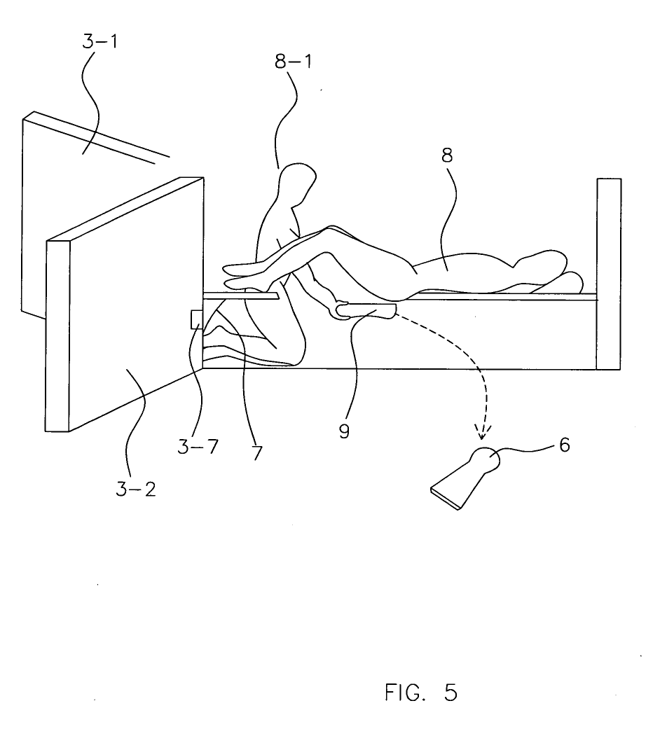

FIG. 6 is a schematic drawing that shows how the key hole shape panel (6) is used. The foot panel (3) is comprised of two pieces (3-1), (3-2) that can be open from the center (3-3). One end of each piece (3-4), (3-5) is foldably attached to the bottom frame (7) via pluralities of hinges (3-6), (3-7).

When the user (8) is very weak and need some help for excretion, an assistant (opens the foot panel (3) if there is a foot panel), removes the key hole shape pane (6) and let the user open legs, get into the wide portion of the groove (6-2), and place a excreting tool (9) beneath the bottom of the user (8) to take the excretions from the user (8).

If there is a foot panel (3), that is comprised of two pieces that can be open from the center and one end of each piece is foldably attached to the bottom frame via pluralities of hinges, the assistance should open the foot panel (3) and access to the key hole shape panel (6).

From the above explanation, it is clear that a user (8) who is very weak and should be on bed for long time can avoid bed sore and can treat the excretion without moving out of the bed.

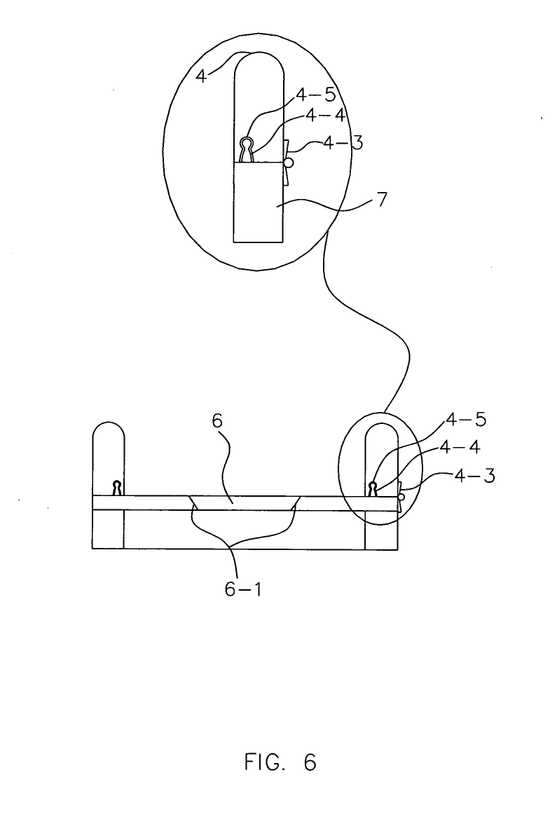

FIG. 7 is a cross sectional view of the bed (1) seen from the B-B′ cut away line showing the folding mechanism of the side support panels (4). When the user (8) is recovered little bit and want to sit up, one side of the support panels (4) can be folded down to allow the user sit up on one side of the bed (1) by folding down a side support panel (4). The other extreme case is when the user passed away and need to be removed from the bed (1), fold down one of the side support pane (4) will make it easy to remove the user(8)'s body from the bed (1).

For that, the side support panel (4) is connected to the side bottom frames (7) pluralities of hinges (4-3). Pluralities of protruding pins (4-4) are fixed on the upper surface of one side bottom frame (7) and pluralities of grooves (4-5) are developed on the lower surface of one of the side support panel (4).

FIG. 8 is a schematic drawing of the bed (1) according to current application when one of the side supports (4) is folded down.

It is clear that the bed according to current application not only provides a comfortable bed that prevents bed sores for invalids and sleep disturbing patient but also a comfortable sleeping aid bed, which is also good for stretching or passive or active exercise, for healthy users.

1-3. (canceled)

4. A comfortable bed preventing bed sores for invalids and sleep disturbing patient comprises of;
one head panel, and
two side bottom frames, and
one foot panel that comprises of two pieces that can be open from the center and one end of each piece is foldably attached to the bottom frame via pluralities of hinges, and
two side support panels; each of which comprises of a rigid portion that has a groove, which comprises of two smooth rounded concave connected in series, to receive the resilient portion and
a soft resilient portion that comprises of one body of soft rubbery material, such as poly-urethane or silicon rubber, one side of which has two smooth rounded convex humps connected in series and the other side is straight and is connected to the side bottom frames via pluralities of hinges, and
pluralities of protruding pins which are fixed on the upper surface of one side the bottom frame, and
pluralities of grooves which are developed on the lower surface of the side support panel, and
one bed plate, and
one removable key-hole shape panel that is engaged to a groove on the bed plate and comprises of the same material as the bed plate.

5-6. (canceled)
